(19) United States
(12) Patent Application Publication
(10) Pub. No.: US 2026/0139133 A1
(43) Pub. Date: May 21, 2026

(54) POLYPROPYLENE COMPOSITION SUITABLE FOR FOAMED INJECTION MOULDED ARTICLES

(71) Applicant: BOREALIS AG, Vienna (AT)

(72) Inventors: Antti Tapio Tynys, Linz (AT); Daniela Mileva, Linz (AT); Hermann Braun, Linz (AT); Dietrich Gloger, Linz (AT)

(21) Appl. No.: 19/118,837

(22) PCT Filed: Oct. 12, 2023
(86) PCT No.: PCT/EP2023/078380

§ 371 Date: Apr. 7, 2025

(30) Foreign Application Priority Data
Oct. 14, 2022 (EP) 22201547.1

(51) Int. Cl. C08L 23/14; C08J 9/00; C08J 9/06

(52) U.S. Cl. CPC C08L 23/142; C08J 9/0061; C08J 9/06; C08J 2323/14; C08J 2423/08; C08J 2423/12; C08L 2203/14; C08L 2203/30; C08L 2205/025; C08L 2205/03; C08L 2207/02

(57) ABSTRACT

The present invention relates to a polypropylene composition comprising from 55.0 to 97.5 wt.-% of a heterophasic propylene copolymer (A), from 2.5 to 25.0 wt.-% of a high melt strength propylene homopolymer (B) and from 0 to 20.0 wt.-% of a copolymer of ethylene with at least one comonomer selected from alpha-olefins having from 4 to 10 carbon atoms, an injection-molded article comprising said polypropylene composition, a foamed article comprising said polypropylene composition and the use of said polypropylene composition for the production of a foamed article.

The present invention relates to a polypropylene composition comprising from 55.0 to 97.5 wt.-% of a heterophasic propylene copolymer (A), from 2.5 to 25.0 wt.-% of a high melt strength propylene homopolymer (B) and from 0 to 20.0 wt.-% of a copolymer of ethylene with at least one comonomer selected from alpha-olefins having from 4 to 10 carbon atoms, an injection-molded article comprising said polypropylene composition, a foamed article comprising said polypropylene composition and the use of said polypropylene composition for the production of a foamed article.

### TECHNICAL BACKGROUND

Plastic materials featured by a reduced weight with preservation of the mechanical property profile are gaining more and more interest e.g. in the automotive industry and packaging industry. Thereby, foam injection-moulding technology can be used to produce low-density parts.

One established method for preparing foam injection-moulded parts especially in automotive industry is core-back injection moulding. Thereby, a polymer composition, such as a polypropylene composition, is melted and injected into a mold together with a foaming agent. The mold filled with said composition is then opened by a predetermined degree, which activates the foaming agent and introduces bubbles into the injected composition. Normally the achieved density reduction when using core-back foam injection moulding technology has been up to 30% as higher density reduction leads to deteriorated foam structure and foam properties. The limited maximum density reduction restricts the applicability of the technology in other applications in which higher density reduction is needed. As an example, a multiple use beverage cup for hot and/or cold drinks, can be mentioned.

A high foaming degree nor only reduces the density of the foamed article but also brings other desired properties, like improvement in thermal insulation performance. In addition to the low density, the final article needs to show good surface quality and sufficient mechanical performance to be usable in the target application. In many cases, foamed articles do not have sufficient toughness and due to the brittle nature of the final article the usability the foamed articles is limited, especially in case of high density reduction.

Thus, there is a need for a polypropylene composition, which can be used for the production of foamed injection moulded articles with a high density reduction and an improved balance of properties in regard of toughness and stiffness.

The present invention provides a polypropylene composition which when foamed in the presence of a blowing agent, provides a foamed article with a surprisingly improved balance of properties of low density, high toughness, determined as high puncture energy and high stiffness, determined as high flexural modulus and high tensile properties.

### SUMMARY OF THE INVENTION

The present invention relates to a polypropylene composition comprising
(A) from 55.0 to 97.5 wt.-%, preferably from 65.0 to 96.5 wt.-%, more preferably from 70.0 to 95.0 wt.-%, based on the total weight of the composition, of a heterophasic propylene copolymer comprising a matrix phase and an elastomeric phase dispersed in said matrix phase and having an amount of xylene cold solubles (XCS) fraction of from 10.0 to 25.0 wt.-%, preferably from 11.5 to 22.5 wt.-%, more preferably from 12.5 wt.-% to 20.0 wt.-% based on the total amount of the heterophasic propylene copolymer (A);
(B) from 2.5 to 25.0 wt.-%, preferably from 3.5 to 20.0 wt.-%, more preferably from 5.0 to 15.0 wt.-%, based on the total weight of the composition, of a high melt strength propylene homopolymer having a melt flow rate MFR₂ of from 0.5 to 5.0 g/10 min, preferably 1.0 to 3.0 g/10 min, and more preferably 1.2 to 2.5 g/10 min, determined according to ISO 1133 at a temperature of 230° C. and a load of 2.16 kg;
(C) from 0 to 20.0 wt.-%, preferably from 0 to 15.0 wt.-%, more preferably from 0 to 12.5 wt.-%, based on the total weight of the composition, of a copolymer of ethylene with at least one comonomer selected from alpha-olefins having from 4 to 10 carbon atoms, having a density of from 860 to 880 kg/m³, preferably from 862 to 877 kg/m², more preferably from 865 to 875 kg/m³, determined according to ISO 1183, and a melt flow rate MFR₂ of from 0.1 to 2.5 g/10 min, preferably from 0.2 to 2.0 g/10 min, more preferably from 0.5 to 1.5 g/10 min, determined according to ISO 1133 at a temperature of 190° C. and a load of 2.16 kg.

According to one preferred embodiment of the present invention, a polypropylene composition is provided having a melt flow rate MFR₂ of from 10.0 to 55.0 g/10 min, determined according to ISO 1133 at a temperature of 230° C. and a load of 2.16 kg, the polypropylene composition comprising
(A) from 55.0 to 97.5 wt.-%, preferably from 65.0 to 96.5 wt.-%, more preferably from 70.0 to 95.0 wt.-%, based on the total weight of the composition, of a heterophasic propylene copolymer comprising a matrix phase and an elastomeric phase dispersed in said matrix phase and having an amount of xylene cold solubles (XCS) fraction of from 10.0 to 25.0 wt.-%, preferably from 11.5 to 22.5 wt.-%, more preferably from 12.5 wt.-% to 20.0 wt.-% based on the total amount of the heterophasic propylene copolymer (A);
(B) from 2.5 to 25.0 wt.-%, preferably from 3.5 to 20.0 wt.-%, more preferably from 5.0 to 15.0 wt.-%, based on the total weight of the composition, of a high melt strength propylene homopolymer having a melt flow rate MFR₂ of from 0.5 to 5.0 g/10 min, preferably 1.0 to 3.0 g/10 min, and more preferably 1.2 to 2.5 g/10 min, determined according to ISO 1133 at a temperature of 230° C. and a load of 2.16 kg;
(C) from 0 to 20.0 wt.-%, preferably from 0 to 15.0 wt.-%, more preferably from 0 to 12.5 wt.-%, based on the total weight of the composition, of a copolymer of ethylene with at least one comonomer selected from alpha-olefins having from 4 to 10 carbon atoms, having a density of from 860 to 880 kg/m³, preferably from 862 to 877 kg/m², more preferably from 865 to 875 kg/m³, determined according to ISO 1183, and a melt flow rate MFR₂ of from 0.1 to 2.5 g/10 min, preferably from 0.2 to 2.0 g/10 min, more preferably from 0.5 to 1.5 g/10 min, determined according to ISO 1133 at a temperature of 190° C. and a load of 2.16 kg.

Further, the present invention relates to an injection-molded article comprising the polypropylene composition as described above or below.

Still further, the present invention relates to a foamed article, preferably foamed injection-molded article, comprising the polypropylene composition as described above or below.

Finally, the present invention relates to the use of the polypropylene composition as described above or below and a foaming agent for the production of a foamed article, preferably a foamed injection moulded article.

### Definitions

A heterophasic polypropylene is a propylene-based copolymer with a crystalline matrix phase, which can be a propylene homopolymer or a random copolymer of propylene and at least one alpha-olefin comonomer, and an elastomeric phase dispersed therein. In case of a random heterophasic propylene copolymer, said crystalline matrix phase is a random copolymer of propylene and at least one alpha-olefin comonomer.

The elastomeric phase can be a propylene copolymer with a high amount of comonomer that is not randomly distributed in the polymer chain but is distributed in a comonomer-rich block structure and a propylene-rich block structure. A heterophasic polypropylene usually differentiates from a one-phasic propylene copolymer in that it shows two distinct glass transition temperatures Tg which are attributed to the matrix phase and the elastomeric phase.

The expression “propylene homopolymer” relates to a polypropylene that consists substantially, i.e. of at least 99.0 wt %, more preferably of at least 99.5 wt %, still more preferably of at least 99.8 wt %, like at least 99.9 wt % of propylene units. In another embodiment, only propylene units are detectable, i.e. only propylene has been polymerized.

A propylene random copolymer is a copolymer of propylene monomer units and comonomer units in which the comonomer units are distributed randomly over the polymeric chain. The propylene random copolymer can comprise comonomer units from one or more comonomers different in their amounts of carbon atoms. A propylene random copolymer does not include an elastomeric phase.

An ethylene copolymer is a copolymer of ethylene monomer units and comonomer units. Thereby, the ethylene monomer units make up the molar majority of the ethylene copolymer, i.e. more than 50 mol-% of the ethylene copolymer.

A plastomer is a polymer that combines the qualities of elastomers and plastics, such as rubber-like properties with the processing abilities of plastic.

An ethylene-based plastomer is a plastomer with a molar majority of ethylene monomer units.

Percentages are usually given herein as weight-% (wt.-%) if not stated otherwise.

### General Description

### Polypropylene Composition

In one aspect the present invention is related to a polypropylene composition.

The polypropylene composition comprises as polymeric components from 55.0 to 97.5 wt.-%, preferably from 65.0 to 96.5 wt.-%, more preferably from 70.0 to 95.0 wt.-% of a heterophasic propylene copolymer (A), from 2.5 to 25.0 wt.-%, preferably from 3.5 to 20.0 wt.-%, more preferably from 5.0 to 15.0 wt.-% of a high melt strength propylene homopolymer (B) and from 0 to 20.0 wt.-% preferably from 0 to 15.0 wt.-%, more preferably from 0 to 12.5 wt.-% of a copolymer of ethylene with at least one comonomer selected from alpha-olefins having from 4 to 10 carbon atoms, all based on the total weight of the polypropylene composition.

The polypropylene composition can comprise further polymeric components different from components (A), (B) and (C) in amounts of up to 10 wt.-%.

It is, however, preferred that the polymeric components of the polypropylene composition consist of components (A), (B) and optionally (C).

The polymeric components, preferably components (A), (B) and optionally (C), preferably make up from 80.0 to 100 wt.-%, more preferably from 85.0 to 99.999 wt.-%, still more preferably from 97.5 to 99.99 wt.-% of the polypropylene composition.

The polypropylene composition can further comprise an inorganic filler in an amount of from 0 to 20.0 wt.-%, preferably from 0 to 15.0 wt.-%, based on the total weight of the polypropylene composition.

Preferably the inorganic filler is a mineral filler. It is appreciated that the inorganic filler is a phyllosilicate, mica or wollastonite. Even more preferred the inorganic filler is selected from the group consisting of mica, wollastonite, kaolinite, smectite, montmorillonite and talc.

The most preferred inorganic fillers are talc and/or wollastonite.

It is however preferred that the polypropylene composition does not comprise an inorganic filler.

Further, the polypropylene composition can comprise additives in an amount of from 0 to 10.0 wt.-%, preferably from 0.001 to 5.0 wt.-%, more preferably from 0.01 to 3.5 wt.-%, based on the total weight of the polypropylene composition. Typical additives are acid scavengers, antioxidants, colorants, light stabilisers, plasticizers, slip agents, anti-scratch agents, dispersing agents, processing aids, lubricants, pigments, and the like. The optional inorganic filler is not regarded as an additive. Such additives are commercially available and for example described in “Plastic Additives Handbook”, 6th edition 2009 of Hans Zweifel (pages 1141 to 1190).

The polypropylene composition preferably has a density of from 890 to 1100 kg/m³.

Thereby, the density depends on the presence of an inorganic filler.

If no inorganic filler is present the polypropylene composition preferably has a density of from 890 to 915 kg/m³, more preferably from 895 to 910 kg/m³.

In the presence of an inorganic filler the polypropylene composition can have a density of up to 1100 kg/m³.

Further, the polypropylene composition preferably has a melt flow rate MFR₂ of from 10.0 to 55.0 g/10 min, preferably from 15.0 to 50.0 g/10 min, more preferably from 17.0 to 45.0 g/10 min, determined according to ISO 1133 at a temperature of 230° C. and a load of 2.16 kg.

The polypropylene composition preferably shows a good balance of properties in regard of stiffness and toughness. This can be preferably be seen in the following properties:

The polypropylene composition preferably has a flexural modulus of from 1200 to 2000 MPa, more preferably from 1300 MPa to 1850 MPa, still more preferably from 1400 MPa to 1750 MPa.

Furthermore, the polypropylene composition preferably has a max force at 23° C. of from 1750 to 2750 N, more preferably from 2000 to 2600 N, still more preferably from 2100 to 2500 N.

Additionally, the polypropylene composition preferably has an energy to max force at 23° C. of from 10 to 20 J, more preferably from 12 to 18 J, still more preferably from 13 to 17 J.

Further, the polypropylene composition preferably has a puncture energy at 23° C. of from 15 to 35 J, more preferably from 18 to 32 J, still more preferably from 20 to 30 J.

Still further, the polypropylene composition preferably has a tensile modulus of from 1200 to 2000 MPa, more preferably from 1300 MPa to 1850 MPa, still more preferably from 1400 MPa to 1800 MPa.

Furthermore, the polypropylene composition preferably has a tensile strain at break of from 10 to 75%, more preferably from 12 to 70%, still more preferably from 15 to 60%.

Additionally, the polypropylene composition preferably has a tensile strain at tensile strength of from 2.0 to 7.5%, more preferably from 2.5 to 7.0%, still more preferably from 3.0 to 6.5%.

Further, the polypropylene composition preferably has a tensile strain at yield of from 2.0 to 7.5%, more preferably from 2.5 to 7.0%, still more preferably from 3.0 to 6.5%.

Still further, the polypropylene composition preferably has a tensile strength of from 15 to 50 MPa, more preferably from 20 to 45 MPa, still more preferably from 23 to 40 MPa.

Furthermore, the polypropylene composition preferably has a tensile stress at break of from 10 to 35 MPa, more preferably from 13 to 30 MPa, still more preferably from 15 to 25 MPa.

Further, the polypropylene composition preferably has a tensile stress at yield of from 15 to 50 MPa, more preferably from 20 to 45 MPa, still more preferably from 23 to 40 MPa.

The polypropylene composition may have a specific branching index, determined according to GPC-VISC-MALS analysis. The GPC-VISC-MALS analysis may be carried out as described herein below in section “Measuring methods” of the present disclosure. The GPC-VISC-MALS analysis may be carried out using the polypropylene composition in melt blended form. The branching index, determined according to GPC-VISC-MALS analysis, may correlate with the amount of high melt strength propylene homopolymer (B) being present in the polypropylene composition. Thus, the branching index may also be used to determine the amount of high melt strength propylene homopolymer (B).

The polypropylene composition may have a branching index, as determined according to GPC-VISC-MALS analysis, of in a range of 0.01 to 0.45, preferably in a range of 0.01 to 0.40, more preferably in a range of 0.02 to 0.38, like in a range of 0.03 to 0.35 or in a range of 0.04 to 0.32.

The polypropylene composition is preferably produced by melt blending components (A), (B), optionally component (C) and further optional components as described above in a compounding device such as an extruder. Suitable extruders are e.g. twin-screw extruders. The compounding conditions are usually as known in the art.

### Heterophasic Propylene Copolymer (A)

The polypropylene composition comprises the heterophasic propylene copolymer (A) in an amount of from 55.0 to 97.5 wt.-%, preferably from 65.0 to 96.5 wt.-%, more preferably from 70.0 to 95.0 wt.-%, based on the total weight of the composition.

The heterophasic propylene copolymer (A) comprises a matrix phase and an elastomeric phase dispersed in said matrix phase.

The heterophasic propylene copolymer (A) has an amount of xylene cold solubles (XCS) fraction of from 10.0 to 25.0 wt.-%, preferably from 11.5 to 22.5 wt.-%, more preferably from 12.5 wt.-% to 20.0 wt.-% based on the total amount of the heterophasic propylene copolymer (A).

The xylene cold solubles fraction (XCS) of heterophasic propylene copolymer (A) preferably has an intrinsic viscosity (IV (XCS)) in the range from 2.00 to 4.00 dl/g, more preferably in the range from 2.30 to 3.70 dl/g, still more preferably in the range from 2.50 to 3.40 dl/g, most preferably in the range from 2.70 to 3.30 dl/g.

The xylene cold soluble fraction (XCS) of the heterophasic propylene copolymer (A) preferably has an ethylene content (C2(XCS)), measured by Infrared Spectroscopy during CRYSTEX analysis, in the range from 20.0 to 60.0 wt.-%, more preferably in the range from 25.0 to 50.0 wt.-%, still more preferably in the range from 30.0 to 45.0 wt.-%, most preferably in the range from 32.5 to 40.0 wt.-%.

The heterophasic propylene copolymer (A) preferably has a crystalline fraction (CF) determined according to CRYSTEX QC method ISO 6427-B, present in an amount in the range from 72.5 to 92.0 wt.-%, more preferably 75.0 to 90.0 wt.-%, still more preferably in the range from 77.5 to 88.0 wt.-%, most preferably in the range from 80.0 to 87.5 wt.-%, relative to the total weight of the heterophasic propylene copolymer (A).

The crystalline fraction (CF) of the heterophasic propylene copolymer (A) preferably has an intrinsic viscosity (IV (CF)) in the range from 0.90 to 2.00 dl/g, more preferably in the range from 1.00 to 1.80 dl/g, still more preferably in the range from 1.05 to 1.60 dl/g, most preferably in the range from 1.10 to 1.50 dl/g.

The crystalline fraction (CF) of the heterophasic propylene copolymer (A) preferably has an ethylene content (C2(CF)), measured by Infrared Spectroscopy during CRYSTEX analysis, in the range from 0.5 to 5.0 wt.-%, more preferably from in the range from 1.0 to 4.0 wt.-%, still more preferably in the range from 1.3 to 3.0 wt.-%, most preferably in the range from 1.5 to 2.0 wt.-%.

The heterophasic propylene copolymer (A) preferably has a soluble fraction (SF) determined according to CRYSTEX QC method ISO 6427-B, present in an amount in the range from 8.0 to 27.5 wt.-%, more preferably in the range from 10.0 to 25.0 wt.-%, still more preferably in the range from 12.0 to 22.5 wt.-%, most preferably in the range from 12.5 to 20.0 wt.-%, relative to the total weight of the heterophasic propylene copolymer (A).

The soluble fraction (SF) of the heterophasic propylene copolymer (A) preferably has an intrinsic viscosity (IV (SF)) in the range from 1.80 to 4.00 dl/g, more preferably in the range from 2.00 to 3.50 dl/g, still more preferably in the range from 2.20 to 3.50 dl/g, most preferably in the range from 2.40 to 3.30 dl/g.

The soluble fraction (SF) of the heterophasic propylene copolymer (A) preferably has an ethylene content (C2(SF)), measured by Infrared Spectroscopy during CRYSTEX analysis, in the range from 20.0 to 60.0 wt.-%, more preferably in the range from 22.5 to 50.0 wt.-%, still more preferably in the range from 25.0 to 45.0 wt.-%, most preferably in the range from 30.0 to 40.0 wt.-%.

The ratio of the intrinsic viscosity of the soluble fraction to the intrinsic viscosity of the crystalline fraction (IV (SF)/IV (CF)) of the heterophasic propylene copolymer (A) is preferably in the range from 1.00 to 3.00, more preferably in the range from 1.30 to 2.70, still more preferably in the range from 1.60 to 2.50, most preferably in the range from 1.80 to 2.40.

The heterophasic propylene copolymer (A) preferably consists of propylene monomer units and ethylene monomer units.

The heterophasic propylene copolymer (A) preferably has a total ethylene content (C2), measured by in the range from 3.0 to 15.0 wt.-%, more preferably in the range from 4.0 to 12.0 wt.-%, still more preferably in the range from 5.0 to 10.0 wt.-%, most preferably in the range from 6.0 to 8.5 wt.-%.

The heterophasic propylene copolymer (A) preferably has a melt flow rate MFR₂, measured according to ISO 1133-1 at 230° C. at a load of 2.16 kg, in the range from 15.0 to 100.0 g/10 min, more preferably in the range from 20.0 to 90.0 g/10 min, still more preferably in the range from 25.0 to 85.0 g/10 min, most preferably in the range from 30.0 to 80.0 g/10 min.

The heterophasic propylene copolymer (A) can be polymerized via methods well known in the art, or alternatively may be a commercially available polypropylene grade. It would be understood that commercially available grades would be likely to contain common additives.

In one embodiment, the heterophasic propylene copolymer (A) consists of a single heterophasic propylene copolymer.

In said embodiment, the single heterophasic propylene copolymer (A) preferably has a melt flow rate MFR₂, measured according to ISO 1133-1 at 230° C. at a load of 2.16 kg, in the range from 15.0 to 55.0 g/10 min, more preferably in the range from 20.0 to 50.0 g/10 min, still more preferably in the range from 25.0 to 47.0 g/10 min, most preferably in the range from 30.0 to 45.0 g/10 min.

In another embodiment the heterophasic propylene copolymer (A) comprises, preferably consists of two or more, such as two to five, preferably two or three, most preferably two heterophasic propylene copolymers (A-1) and (A-2).

The heterophasic propylene copolymers (A-1) and (A-2) differ in their melt flow rates MFR₂. Thereby, the heterophasic propylene copolymer (A-1) has a lower melt flow rate MFR₂ as the heterophasic propylene copolymer (A-2).

The heterophasic propylene copolymer (A-1) preferably has a melt flow rate MFR₂, measured according to ISO 1133-1 at 230° C. at a load of 2.16 kg, in the range from 15.0 to 55.0 g/10 min, more preferably in the range from 20.0 to 50.0 g/10 min, still more preferably in the range from 25.0 to 47.0 g/10 min, most preferably in the range from 30.0 to 45.0 g/10 min.

The heterophasic propylene copolymer (A-2) preferably has a melt flow rate MFR₂, measured according to ISO 1133-1 at 230° C. at a load of 2.16 kg, in the range from more than 55.0 to 100.0 g/10 min, such as from 57.0 to 100.0 g/10 min, more preferably in the range from 60.0 to 90.0 g/10 min, still more preferably in the range from 62.5 to 85.0 g/10 min, most preferably in the range from 65.0 to 80.0 g/10 min.

The weight ratio of heterophasic propylene copolymer (A-1) to heterophasic propylene copolymer (A-2) in the polypropylene composition is preferably in the range of from 40:60 to 60:40, more preferably from 45:55 to 55:45.

The heterophasic propylene copolymer (A-1) is preferably present in the polypropylene composition in an amount of from 25.0 to 55.0 wt.-%, more preferably from 30.0 to 54.0 wt.-%, still more preferably from 32.5 to 52.5 wt.-%, based on the total weight of the polypropylene composition.

The heterophasic propylene copolymer (A-2) is preferably present in the polypropylene composition in an amount of from 25.0 to 55.0 wt.-%, more preferably from 30.0 to 54.0 wt.-%, still more preferably from 32.5 to 52.5 wt.-%, based on the total weight of the polypropylene composition.

### High Melt Strength Propylene Homopolymer (B)

The polypropylene composition comprises the high melt strength propylene homopolymer in an amount of from 2.5 to 25.0 wt.-%, preferably from 3.5 to 20.0 wt.-%, more preferably from 5.0 to 15.0 wt.-%, based on the total weight of the composition.

A high melt strength propylene polymer is branched and, thus, differs from a linear propylene polymer in that the polypropylene backbone covers side chains whereas a non-branched propylene polymer, i.e. a linear propylene polymer, does not cover side chains. The side chains have significant impact on the rheology of the propylene polymer. Accordingly linear propylene polymers and high melt strength propylene polymers can be clearly distinguished by their flow behaviour under stress (e.g. a ratio of polymer melt viscosities measured under differing loads). Additionally or alternatively, long chain branching can be determined by analysing the content of long chain branches by NMR and/or by measuring the long chain branching index g′ by using e.g. SEC/VISC-LS (size exclusion chromatography/viscometry-light scattering) as known in the art. Branching index g′ is a parameter of the degree of branching. The branching index g′ correlates with the amount of branches of a polymer. A low g′-value is an indicator for a highly branched polymer. In other words, if the g′-value decreases, the branching of the polypropylene increases. For instance, the value of g′ of at least 0.96, such as at least 0.97 or at least 0.98 typically indicates that long chain branches are not present. On the other hand, a value of g′ of 0.9 or less (e.g. 0.6 to 0.9), such as 0.8 or less, typically indicates that the polymer contains long chain branches. Further details regarding branching index g′ and methods for its determination are described, for example, in the section “Measuring methods” of EP3280748B1, which is incorporated herein by reference. The branching index g′ measured using SEC/VISC-LS analysis is different to the branching index measured using GPC-VISC-MALS analysis, as described herein above and below in connection with the polypropylene composition according to embodiments of the present invention.

Branching can be generally achieved by using specific catalysts, i.e. specific single-site catalysts, or by chemical modification. Concerning the preparation of a branched propylene polymer obtained by the use of a specific catalyst reference is made to EP 1 892 264. With regard to a branched propylene polymer obtained by chemical modification it is referred to EP 0 787 750, EP 0 879 830 A1 and EP 0 890 612 A2 . . . . In such a case the branched propylene polymer is also called high melt strength propylene polymer. The high melt strength propylene homopolymer (B) is preferably obtained by chemical modification of a propylene polymer as described in more detail below. High melt strength propylene homopolymers are commercially available from Borealis AG under the trade name Daploy™.

In case the high melt strength propylene homopolymer (B) is a high melt strength propylene homopolymer which is obtained by chemical modification of a linear propylene homopolymer, the definition of propylene homopolymer is to be understood to refer to the linear propylene homopolymer which is used to obtain the high melt strength propylene homopolymer (B) by chemical modification, e.g. with bifunctionally unsaturated monomer(s) and/or multifunctionally unsaturated low molecular weight polymer(s) in reactive extrusion.

High melt strength propylene homopolymers typically have a comparatively low melt flow rate combined with high melt strength and a high melt extensibility.

The high melt strength propylene homopolymer (B) preferably has an F₃₀ melt strength of more than 20.0 cN and a v₃₀ melt extensibility of more than 200 mm/s, preferably has an F₃₀ melt strength of more than 20.0 to 50.0 cN and a v₃₀ melt extensibility of more than 200 to 300 mm/s. The F₃₀ melt strength and the v₃₀ melt extensibility are measured according to ISO 16790:2005.

The high melt strength propylene homopolymer (B) preferably has specific properties, like specific melt properties.

The high melt strength propylene homopolymer (B) preferably has a melt strength F₃₀ (ISO 16790:2005) of 20.0 to 50.0 cN, preferably in the range of 25.0 to 45.0 cN, and more preferably in the range of 30.0 to 40.0 cN, like in the range of 32.0 to 38.0 cN.

The high melt strength propylene homopolymer (B) preferably has a melt extensibility v₃₀ (ISO 16790:2005) in the range of 190 to 320 mm/s, preferably 210 to 300 mm/s, and more preferably 230 to 280 mm/s, like in the range of 240 to 280 mm/s.

The high melt strength propylene homopolymer (B) has a melt flow rate MFR₂ (ISO 1133, 2.16 kg load, 230° C.) in the range of 0.5 to 5.0 g/10 min, preferably 1.0 to 3.0 g/10 min, and more preferably 1.2 to 2.5 g/10 min, like in the range of 1.4 to 2.3 g/10 min.

According to one preferred embodiment, the high melt strength propylene homopolymer (B) has two or more, and more preferably all, of the following properties:
i) a melt strength F₃₀ (ISO 16790:2005) of 20.0 to 50.0 cN, preferably in the range of 25.0 to 45.0 cN, and more preferably in the range of 30.0 to 40.0 cN, like in the range of 32.0 to 38.0 cN,
ii) a melt extensibility v₃₀ (ISO 16790:2005) in the range of 190 to 320 mm/s, preferably 210 to 300 mm/s, and more preferably 230 to 280 mm/s, like in the range of 240 to 280 mm/s,
iii) a melt flow rate MFR₂ (ISO 1133, 2.16 kg load, 230° C.) in the range of 0.5 to 5.0 g/10 min, preferably 1.0 to 3.0 g/10 min, and more preferably 1.2 to 2.5 g/10 min, like in the range of 1.4 to 2.3 g/10 min.

The high melt strength propylene homopolymer (B) can have a melting point of at least 130° C., more preferably of at least 135° C. and most preferably of at least 140° C. The crystallization temperature may be at least 110° C., more preferably at least 120° C.

The high melt strength propylene homopolymer (B) may comprise unsaturated units, like bifunctionally unsaturated monomer(s) and/or multifunctionally unsaturated low molecular weight polymer(s) as defined in detail below, being different to propylene. Accordingly the definition of homopolymer in view of the high melt strength propylene homopolymer (B) refers actually to the unmodified propylene homopolymer which is preferably a linear polypropylene, used to obtain the high melt strength propylene homopolymer (B) by chemical modification as defined in detail below.

Accordingly in one preferred embodiment the high melt strength propylene homopolymer (B) comprises units derived from
(i) propylene and
(ii) bifunctionally unsaturated monomer(s) and/or multifunctionally unsaturated low molecular weight polymer(s).

“Bifunctionally unsaturated” or “multifunctionally unsaturated” as used above means preferably the presence of two or more non-aromatic double bonds, as in e.g. divinylbenzene or cyclopentadiene or polybutadiene. Only such bi- or multifunctionally unsaturated compounds are used which can be polymerized preferably with the aid of free radicals (see below). The unsaturated sites in the bi- or multifunctionally unsaturated compounds are in their chemically bound state not actually “unsaturated”, because the double bonds are each used for a covalent bond to the polymer chains of the unmodified propylene homopolymer preferably of the linear propylene homopolymer.

Reaction of the bifunctionally unsaturated monomer(s) and/or multifunctionally unsaturated low molecular weight polymer(s), preferably having a number average molecular weight (Mn)≤10000 g/mol, synthesized from one and/or more unsaturated monomers with the unmodified propylene homopolymer, preferably with the linear propylene homopolymer, are performed in the presence of a thermally free radical forming agent, e. g. decomposing free radical-forming agent, like a thermally decomposable peroxide.

The bifunctionally unsaturated monomers may be
divinyl compounds, such as divinylaniline, m-divinylbenzene, p-divinylbenzene, divinylpentane and divinylpropane;
allyl compounds, such as allyl acrylate, allyl methacrylate, allyl methyl maleate and allyl vinyl ether;
dienes, such as 1,3-butadiene, chloroprene, cyclohexadiene, cyclopentadiene, 2,3-dimethylbutadiene, heptadiene, hexadiene, isoprene and 1,4-pentadiene;
aromatic and/or aliphatic bis (maleimide) bis (citraconimide) and mixtures of these unsaturated monomers.

Especially preferred bifunctionally unsaturated monomers are 1,3-butadiene, isoprene, dimethyl butadiene and divinylbenzene.

The multifunctionally unsaturated low molecular weight polymer, preferably having a number average molecular weight (Mn)≤10000 g/mol may be synthesized from one or more unsaturated monomers.

Examples of such low molecular weight polymers are
polybutadienes, especially where the different microstructures in the polymer chain, i.e. 1,4-cis, 1,4-trans and 1,2-(vinyl) are predominantly in the 1,2-(vinyl) configuration
copolymers of butadiene and styrene having 1,2-(vinyl) in the polymer chain.

A preferred low molecular weight polymer is polybutadiene, in particular a polybutadiene having more than 50.0 wt % of the butadiene in the 1,2-(vinyl) configuration.

The high melt strength propylene homopolymer (B) may contain more than one bifunctionally unsaturated monomer and/or multifunctionally unsaturated low molecular weight polymer. Even more preferred the amount of bifunctionally unsaturated monomer(s) and multifunctionally unsaturated low molecular weight polymer(s) together in the high melt strength propylene homopolymer (B) is 0.01 to 10.0 wt % based on the total weight of said high melt strength propylene homopolymer (B).

In a preferred embodiment the high melt strength propylene homopolymer (B) is free of additives. Accordingly in case the instant polypropylene composition comprises additives (A), these additives are not brought in the polypropylene composition during the manufacture of the high melt strength propylene homopolymer (B).

The high melt strength propylene homopolymer (B) further preferably has a low gel content usually below 1.00 wt %. Preferably the gel content is less than 0.80 wt %, more preferably less than 0.50 wt %.

A suitable high melt strength propylene homopolymer (B) is WB140HMS™ commercially available from Borealis AG.

### Copolymer of Ethylene (C)

The polypropylene composition can further comprise the copolymer of ethylene (C) in an amount of from 0 to 20.0 wt.-%, preferably from 0 to 15.0 wt.-%, more preferably from 0 to 12.5 wt.-%, based on the total weight of the composition.

In one embodiment the polypropylene composition does not comprise the copolymer of ethylene (C). In said embodiment the polymeric components of the polypropylene composition comprise, preferably consists of components (A) and (B) but does not comprise the copolymer of ethylene (C).

In another embodiment the polypropylene composition comprises the copolymer of ethylene (C). In said embodiment the copolymer of ethylene is present in the polypropylene composition in an amount of from 2.5 to 20.0 wt.-%, preferably from 5.0 to 15.0 wt.-%, more preferably from 7.5 to 12.5 wt.-%, based on the total weight of the composition. In said embodiment the polymeric components of the polypropylene composition comprise, preferably consists of components (A), (B) and (C).

The copolymer of ethylene (C) has a density in the range from 860 to 880 kg/m³, preferably from 862 to 877 kg/m², more preferably from 865 to 875 kg/m³.

The copolymer of ethylene (C) has a melt flow rate MFR₂ of from 0.1 to 2.5 g/10 min, preferably from 0.2 to 2.0 g/10 min, more preferably from 0.5 to 1.5 g/10 min.

The copolymer of ethylene (C) comprises at least one, preferably one comonomer selected from alpha-olefins having from 4 to 10 carbon atoms, more preferably from 4 to 8 carbon atoms. Preferably the at least one, preferably the comonomer is selected from 1-hexene or 1-octene, most preferably 1-octene.

It is particularly preferred that the copolymer of ethylene (C) contains 1-octene as the only comonomer(s).

The copolymer of ethylene (C) preferably has a melting temperature Tm of from 40 to 70° C., preferably from 45 to 65° C., more preferably from 50 to 60° C.

The copolymer of ethylene (C) preferably is an ethylene-based plastomer.

The copolymer of ethylene (C) can be polymerized via methods well known in the art, such as in a solution polymerization process preferably in the presence of a single site catalyst, or alternatively may be a commercially available polyethylene grade. It would be understood that commercially available grades would be likely to contain common additives.

### Injection Moulded Article

In another aspect the present invention relates to an injection-moulded article comprising the polypropylene composition as described above or below.

Thereby, preferably all aspects of the polypropylene composition and its components as described above or below apply for the injection-moulded article.

The injection-moulded article preferably is an automotive article or a packaging article.

The injection-moulded article preferably comprises the polypropylene composition in an amount of from 90 to 100 wt %, more preferably from 95 to 100 wt %, based on the total weight of the injection-moulded article.

The injection-moulded article can comprise additional components such as additional polymeric components, fillers or additives in an amount of 0 to 10 wt %, more preferably from 0 to 5 wt %, based on the total weight of the injection-moulded article.

The injection-moulded article preferably has a density of from 890 to 1100 kg/m³.

Thereby, the density depends on the presence of an inorganic filler in the polypropylene composition.

If no inorganic filler is present in the polypropylene composition the injection-moulded article preferably has a density of from 890 to 915 kg/m³, more preferably from 895 to 910 kg/m³.

In the presence of an inorganic filler in the polypropylene composition the injection-moulded article can have a density of up to 1100 kg/m³.

From the density it can be seen that the injection-moulded article preferably is not foamed but is a solid injection-moulded article.

The injection-moulded article preferably shows a good balance of properties in regard of stiffness and toughness. This can be preferably be seen in the following properties:

The injection-moulded article preferably has a flexural modulus of from 1200 to 2000 MPa, more preferably from 1300 MPa to 1850 MPa, still more preferably from 1400 MPa to 1750 MPa.

Furthermore, the injection-moulded article preferably has a max force at 23° C. of from 1750 to 2750 N, more preferably from 2000 to 2600 N, still more preferably from 2100 to 2500 N.

Additionally, the injection-moulded article preferably has an energy to max force at 23° C. of from 10 to 20 J, more preferably from 12 to 18 J, still more preferably from 13 to 17 J.

Further, the injection-moulded article preferably has a puncture energy at 23° C. of from 15 to 35 J, more preferably from 18 to 32 J, still more preferably from 20 to 30 J.

Still further, the injection-moulded article preferably has a tensile modulus of from 1200 to 2000 MPa, more preferably from 1300 MPa to 1850 MPa, still more preferably from 1400 MPa to 1800 MPa.

Furthermore, the injection-moulded article preferably has a tensile strain at break of from 10 to 75%, more preferably from 12 to 70%, still more preferably from 15 to 60%.

Additionally, the injection-moulded article preferably has a tensile strain at tensile strength of from 2.0 to 7.5%, more preferably from 2.5 to 7.0%, still more preferably from 3.0 to 6.5%.

Further, the injection-moulded article preferably has a tensile strain at yield of from 2.0 to 7.5%, more preferably from 2.5 to 7.0%, still more preferably from 3.0 to 6.5%.

Still further, the injection-moulded article preferably has a tensile strength of from 15 to 50 MPa, more preferably from 20 to 45 MPa, still more preferably from 23 to 40 MPa.

Furthermore, the injection-moulded article preferably has a tensile stress at break of from 10 to 35 MPa, more preferably from 13 to 30 MPa, still more preferably from 15 to 25 MPa.

Further, the injection-moulded article preferably has a tensile stress at yield of from 15 to 50 MPa, more preferably from 20 to 45 MPa, still more preferably from 23 to 40 MPa.

### Foamed Article

In yet another aspect the present invention relates to a foamed article comprising the polypropylene composition as described above or below.

Thereby, preferably all aspects of the polypropylene composition and its components as described above or below apply for the foamed article.

The foamed article preferably is a foamed injection-moulded article, more preferably an automotive article or a packaging article.

The foamed injection moulded article is preferably produced by core-back injection moulding as described above.

The foamed article preferably comprises the polypropylene composition in an amount of from 90.0 to 99.9 wt %, more preferably from 95.0 to 99.5 wt %, based on the total weight of the injection-moulded article.

The foamed article is preferably produced by foaming the polypropylene composition in the presence of a foaming agent.

The term “foaming agent” refers to an agent, which is capable of producing a cellular structure in a polypropylene composition during foaming.

The foaming agent can be a physical foaming agent, typically a gas such as carbon dioxide, nitrogen or other inert gases.

It is, however, preferred that the foaming agent is a chemical foaming agent.

Thereby, the polypropylene composition is preferably blended, more preferably melt-blended with the foaming agent, preferably the chemical foaming agent.

The melt of polypropylene composition and foaming agent is the preferably formed into the form of the article, preferably by injection moulding.

When brought into the form of the article, the chemical foaming agent is preferably activated. Upon activation the chemical foaming agent releases a gas, such as nitrogen or carbon dioxide, which formed bubbles within the melt of the article.

Upon solidification of the gas bubbles solidify as cells in the article, thereby forming the foamed article.

When using core-back injection moulding technology for producing the foamed article, the chemical foaming agent is activated by opening the mold by a predetermined degree, such as from 1 mm to 5 mm, preferably from 2 mm to 3 mm.

The chemical foaming agent is preferably introduced into the polypropylene composition in an amount of from 0.1 to 10.0 wt %, more preferably from 0.2 to 5.0 wt %, based on the combined weight of the polypropylene composition and the chemical foaming agent.

The chemical foaming agent preferably is an endothermic chemical foaming agent.

It is preferred that the chemical foaming agent is an organic chemical foaming agent, such as a polycarboxylic acid, like citric acid, fumaric acid, tartric acid, sodium hydrogen citrate, monosodium citrate or combinations thereof.

The chemical foaming agent can also be an inorganic chemical foaming agent, such as a carbonate, like ammonium carbonate or a bivalent bicarbonate, like sodium bicarbonate or zinc bicarbonate.

The chemical foaming agent can also be a mixture of an organic and inorganic chemical foaming agent such as a mixture of a polycarboxylic acid and a bivalent bicarbonate, like sodium bicarbonate or zinc bicarbonate.

The chemical foaming agent preferably releases carbon dioxide as gas, which forms bubbles in the melt.

Preferably upon release of the gas, preferably carbon dioxide, the residual reaction product of the chemical foaming agent forms solid crystals, which can act as nucleating agent for solidification of the melt.

The chemical foaming agent preferably is added to the polypropylene composition in form of a master batch in which the active ingredients of the chemical foaming agent are distributed in a polymer matrix. Preferably, the polymer matrix is an ethylene based polymer, such as a low density polyethylene.

The active ingredients of the chemical foaming agent are preferably present in the master batch in an amount of from 5 to 35 wt.-%, more preferably from 10 to 30 wt.-%, still more preferably from 15 to 25 wt.-%, based on the total amount of the master batch

In the case that the chemical foaming agent is added as master batch, the amount of the polymeric matrix is counted to the amount of the chemical foaming agent instead of the amount of the polypropylene composition.

The chemical foaming agent preferably is activated at a rather high temperature of from 200 to 250° C., more preferably from 210 to 230° C.

Suitable chemical foaming agents are commercially available, such as Panthelene H65C, Panthelene H25C, both commercially available from EIWA CHEMICAL IND. CO., LTD, or Maxithen HP 788810/20 TR, commercially available from Gabriel-Chemie GmbH.

The foamed article preferably has an average cell size in machine direction of from 100 to 200 μm, more preferably from 120 μm to 175 μm, still more preferably from 130 to 160 μm.

Further, the foamed article preferably has an average cell size in transverse direction of from 110 to 225 μm, more preferably from 135 μm to 210 μm, still more preferably from 150 to 200 μm.

The foamed article preferably shows an improved balance of properties of low density, high toughness and high stiffness. This can be preferably be seen in the following properties:

The foamed article preferably has a density of from 350 to 650 kg/m³, preferably from 375 to 625 kg/m³, more preferably from 400 to 600 kg/m³

The foamed article further preferably has a flexural modulus of from 600 to 1200 MPa, preferably from 650 to 1100 MPa, more preferably from 675 to 1050 MPa.

Furthermore, the foamed article preferably has a max force at 23° C. of from 400 to 1750 N, more preferably from 550 to 1600 N, still more preferably from 700 to 1500 N.

Additionally, the foamed article preferably has an energy to max force at 23° C. of from 1.8 to 10.0 J, preferably from 2.0 to 9.0 J.

Further, the foamed article preferably has a puncture energy at 23° C. of from 2.0 to 10.0 J, more preferably from 2.3 to 9.0 J.

Still further, the foamed article preferably has a tensile modulus of from 350 to 800 mPa, preferably from 375 to 775 MPa, more preferably from 400 to 750 MPa.

Furthermore, the foamed article preferably has a tensile strain at break of from 20 to 100%, more preferably from 25 to 85%, still more preferably from 32 to 70%.

Additionally, the foamed article preferably has a tensile strain at tensile strength of from 2.0 to 7.5%, more preferably from 2.5 to 7.0%, still more preferably from 3.0 to 6.5%.

Further, the foamed article preferably has a tensile strain at yield of from 2.5 to 30.0%, more preferably from 5.0 to 25.0%, still more preferably from 7.5 to 20.0%.

Still further, the foamed article preferably has a tensile strength of from 5.0 to 20.0 MPa, more preferably from 6.5 to 15.0 MPa, still more preferably from 7.0 to 12.5 MPa.

Furthermore, the foamed article preferably has a tensile stress at break of from 5.0 to 20.0 MPa, more preferably from 6.5 to 15.0 MPa, still more preferably from 7.0 to 12.5 MPa.

Further, the foamed article preferably has a tensile stress at yield of from 5.0 to 20.0 MPa, more preferably from 6.5 to 15.0 MPa, still more preferably from 7.0 to 12.5 MPa.

The density of the foamed article, i.e. the density reduction of the foamed article, is preferably from 35 to 65%, more preferably from 40 to 55% of the density of an unfoamed injection-molded article of the same polypropylene composition (equivalent to 100%).

Further, the flexural modulus of the foamed article is preferably in the range of from 500 to 1500 MPa, more preferably from 700 to 1200 MPa lower than the flexural modulus of an unfoamed injection-molded article of the same polypropylene composition.

Still further, the puncture energy of the foamed article is preferably in the range of from 10 to 30 J, more preferably from 15 to 25 J lower than the flexural modulus of an unfoamed injection-molded article of the same polypropylene composition.

### Use

IN another aspect the present invention relates to the use of the polypropylene composition as described above or below and a chemical foaming agent for the production of a foamed article, preferably a foamed injection moulded article.

Thereby, preferably all aspects of the polypropylene composition, its components and the foamed article as described above or below apply for the use.

Further non-limiting embodiments and aspects of the present invention are defined in the following items [1] to [15]:
[1] A polypropylene composition comprising
(A) from 55.0 to 97.5 wt.-%, preferably from 65.0 to 96.5 wt.-%, more preferably from 70.0 to 95.0 wt.-%, based on the total weight of the composition, of a heterophasic propylene copolymer comprising a matrix phase and an elastomeric phase dispersed in said matrix phase and having an amount of xylene cold solubles (XCS) fraction of from 10.0 to 25.0 wt.-%, preferably from 11.5 to 22.5 wt.-%, more preferably from 12.5 wt.-% to 20.0 wt.-% based on the total amount of the heterophasic propylene copolymer (A);
(B) from 2.5 to 25.0 wt.-%, preferably from 3.5 to 20.0 wt.-%, more preferably from 5.0 to 15.0 wt.-%, based on the total weight of the composition, of a high melt strength propylene homopolymer having a melt flow rate MFR₂ of from 0.5 to 5.0 g/10 min, preferably 1.0 to 3.0 g/10 min, and more preferably 1.2 to 2.5 g/10 min, determined according to ISO 1133 at a temperature of 230° C. and a load of 2.16 kg;
(C) from 0 to 20.0 wt.-%, preferably from 0 to 15.0 wt.-%, more preferably from 0 to 12.5 wt.-%, based on the total weight of the composition, of a copolymer of ethylene with at least one comonomer selected from alpha-olefins having from 4 to 10 carbon atoms, having a density of from 860 to 880 kg/m³, preferably from 862 to 877 kg/m², more preferably from 865 to 875 kg/m³, determined according to ISO 1183, and a melt flow rate MFR₂ of from 0.1 to 2.5 g/10 min, preferably from 0.2 to 2.0 g/10 min, more preferably from 0.5 to 1.5 g/10 min, determined according to ISO 1133 at a temperature of 190° C. and a load of 2.16 kg.
[2] The polypropylene composition according to item [1], wherein the composition has
   a density of from 890 to 1100 kg/m³, determined according to ISO 1183; and/or
   a melt flow rate MFR₂ of from 10.0 to 55.0 g/10 min, preferably from 15.0 to 50.0 g/10 min, more preferably from 17.0 to 45.0 g/10 min, determined according to ISO 1133 at a temperature of 230° C. and a load of 2.16 kg.
[3] The polypropylene composition according to item [1] or [2], wherein the composition has one or more or all of the following properties:
   a tensile modulus of from 1200 to 2000 MPa, more preferably from 1300 MPa to 1850 MPa, still more preferably from 1400 MPa to 1800 MPa, measured according to ISO 527-1; and/or
   a tensile strain at break of from 10 to 75%, more preferably from 12 to 70%, still more preferably from 15 to 60%, measured according to ISO 527-1; and/or
   a tensile strength of from 15 to 50 MPa, more preferably from 20 to 45 MPa, still more preferably from 23 to 40 MPa, measured according to ISO 527-1; and/or
   a tensile stress at break of from 10 to 35 MPa, more preferably from 13 to 30 MPa, still more preferably from 15 to 25 MPa, measured according to ISO 527-1; and/or
   a flexural modulus of from 1200 to 2000 MPa, more preferably from 1300 MPa to 1850 MPa, still more preferably from 1400 MPa to 1750 MPa, measured according to ISO 178; and/or
   a puncture energy of from 15 to 35 J, more preferably from 18 to 32 J, still more preferably from 20 to 30 J, measured according to ISO 6603-2 at 23° C.; and/or
   a max force at 23° C. of from 1750 to 2750 N, more preferably from 2000 to 2600 N, still more preferably from 2100 to 2500 N, measured according to ISO 6603-2 at 23° C.; and/or
   an energy to max force at 23° C. of from 10 to 20 J, more preferably from 12 to 18 J, still more preferably from 13 to 17 J, measured according to ISO 6603-2 at 23° C.
[4] The polypropylene composition according to any one of items [1] to [3], wherein the heterophasic propylene copolymer (A) has one or more or all of the following properties:
   a melt flow rate MFR₂, measured according to ISO 1133-1 at 230° C. at a load of 2.16 kg, in the range from 15.0 to 100.0 g/10 min, more preferably in the range from 20.0 to 90.0 g/10 min, still more preferably in the range from 25.0 to 85.0 g/10 min, most preferably in the range from 30.0 to 80.0 g/10 min; and/or
   a xylene cold solubles fraction (XCS) determined at 25° C. according to ISO 16152, present in an amount in the range from 8.0 to 25.0 wt.-%, more preferably in the range from 10.0 to 22.5 wt.-%, still more preferably in the range from 11.0 to 21.0 wt.-%, most preferably in the range from 12.5 to 20.0 wt.-%, based on the total weight of the heterophasic propylene copolymer (A); and/or
   an intrinsic viscosity of the xylene cold solubles fraction (IV (XCS)) in the range from 2.00 to 4.00 dl/g, more preferably in the range from 2.30 to 3.70 dl/g, still more preferably in the range from 2.50 to 3.40 dl/g, most preferably in the range from 2.70 to 3.30 dl/g, determined according to DIN ISO 1628/1 in decalin; and/or
   an ethylene content of the xylene cold solubles fraction (C2(XCS)), measured by quantitative ¹³C{¹H} NMR measurement, in the range from 20.0 to 60.0 wt.-%, more preferably in the range from 25.0 to 50.0 wt.-%, still more preferably in the range from 30.0 to 45.0 wt.-%, most preferably in the range from 32.5 to 40.0 wt.-%; and/or
   a total ethylene content (C2), measured by quantitative ¹³C{¹H} NMR measurement, in the range from 3.0 to 15.0 wt.-%, more preferably in the range from 4.0 to 12.0 wt.-%, still more preferably in the range from 5.0 to 10.0 wt.-%, most preferably in the range from 6.0 to 8.5 wt.-%.
[5] The polypropylene composition according to any one of items [1] to [4], wherein the heterophasic propylene copolymer (A) comprises, preferably consists of two heterophasic propylene copolymers (A-1) and (A-2), wherein heterophasic propylene copolymer (A-1) has a lower melt flow rate MFR₂ as heterophasic propylene copolymer (A-2) and the weight ratio of heterophasic propylene copolymer (A-1) to heterophasic propylene copolymer (A-2) in the polypropylene composition is in the range of from 40:60 to 60:40, preferably from 45:55 to 55:45.
[6] The polypropylene composition according to any one of items [1] to [5], wherein the high melt strength propylene homopolymer (B) is branched and the branches are introduced into the polymer chains of the high melt strength propylene homopolymer (B) as side chains by polymerization in the presence of a single site catalyst or by chemical modification.
[7] The polypropylene composition according to any one of items [1] to [6], wherein the high melt strength propylene homopolymer (B) has a melt strength F₃₀ (ISO 16790:2005) of 20.0 to 50.0 cN, preferably in the range of 25.0 to 45.0 cN, and more preferably in the range of 30.0 to 40.0 cN, like in the range of 32.0 to 38.0 cN; and/or a melt extensibility v₃₀ (ISO 16790:2005) in the range of 190 to 320 mm/s, preferably 210 to 300 mm/s, and more preferably 230 to 280 mm/s, like in the range of 240 to 280 mm/s.
[8] The polypropylene composition according to any one of items [1] to [7], wherein the ethylene copolymer (C) is a copolymer of ethylene and 1-octene comonomer units.
[9] An injection-molded article comprising the polypropylene composition according to any one of the items [1] to [8].
[10] The injection-molded article according to item [9], wherein the article has one or more or all of the following properties:
   a tensile modulus of from of from 1200 to 2000 MPa, more preferably from 1300 MPa to 1850 MPa, still more preferably from 1400 MPa to 1800 MPa, measured according to ISO 527-1; and/or
   a tensile strain at break of from 10 to 75%, more preferably from 12 to 70%, still more preferably from 15 to 60%, measured according to ISO 527-1; and/or
   a tensile strength of from 15 to 50 MPa, more preferably from 20 to 45 MPa, still more preferably from 23 to 40 MPa, measured according to ISO 527-1; and/or
   a tensile stress at break of from 10 to 35 MPa, more preferably from 13 to 30 MPa, still more preferably from 15 to 25 MPa, measured according to ISO 527-1; and/or
   a flexural modulus of from 1200 to 2000 MPa, more preferably from 1300 MPa to 1850 MPa, still more preferably from 1400 MPa to 1750 MPa, measured according to ISO 178; and/or
   a puncture energy of from 15 to 35 J, more preferably from 18 to 32 J, still more preferably from 20 to 30 J, measured according to ISO 6603-2 at 23° C.; and/or
   a max force at 23° C. of from 1750 to 2750 N, more preferably from 2000 to 2600 N, still more preferably from 2100 to 2500 N, measured according to ISO 6603-2 at 23° C.; and/or
   an energy to max force at 23° C. of from 10 to 20 J, more preferably from 12 to 18 J, still more preferably from 13 to 17 J, measured according to ISO 6603-2 at 23° C.
[11] A foamed article, preferably foamed injection-molded article, comprising the polypropylene composition according to any one of the items [1] to [8].
[12] The foamed article according to item [11], wherein the polypropylene composition is foamed in the presence of a foaming agent, preferably a chemical foaming agent.
[13] The foamed article according to item or [12], wherein the article one or more or all of the following properties:
   a density measured according to ISO 1183 of from 350 to 650 kg/m³, preferably from 375 to 625 kg/m³, more preferably from 400 to 600 kg/m³;
   a flexural modulus measured according to ISO 178 of from 600 to 1200 MPa, preferably from 650 to 1100 MPa, more preferably from 675 to 1050 MPa;
   a tensile modulus measured according to ISO 527 of from 350 to 800 mPa, preferably from 375 to 775 MPa, more preferably from 400 to 750 MPa;
   a tensile strain at break of from 20 to 100%, more preferably from 25 to 85%, still more preferably from 32 to 70%;
   a tensile strain at tensile strength measured according to ISO 527 of from 2.0 to 7.5%, more preferably from 2.5 to 7.0%, still more preferably from 3.0 to 6.5%;
   a tensile strain at yield measured according to ISO 527 of from 2.5 to 30.0%, more preferably from 5.0 to 25.0%, still more preferably from 7.5 to 20.0%;
   a tensile strength measured according to ISO 527 of from 5.0 to 20.0 MPa, more preferably from 6.5 to 15.0 MPa, still more preferably from 7.0 to 12.5 MPa;
   a tensile stress at break measured according to ISO 527 of from 5.0 to 20.0 MPa, more preferably from 6.5 to 15.0 MPa, still more preferably from 7.0 to 12.5 MPa;
   a tensile stress at yield measured according to ISO 527 of from 5.0 to 20.0 MPa, more preferably from 6.5 to 15.0 MPa, still more preferably from 7.0 to 12.5 MPa;
   an energy to max force measured according to ISO 6603-2 at 23° C. of from 1.8 to 10.0 J, preferably from 2.0 to 9.0 J; and/or
   a puncture energy measured according to ISO 6603-2 at 23° C. of from 2.0 to 10.0 J, preferably from 2.3 to 9.0 J.
[14] The foamed article according to any one of items to [13], wherein the flexural modulus measured according to ISO 178 is in the range of from 500 to 1500 MPa lower than the flexural modulus of an unfoamed injection-molded article measured according to ISO 178.
[15] Use of the polypropylene composition according to any one of items [1] to [8] and a chemical foaming agent for the production of a foamed article, preferably a foamed injection moulded article.

The present invention is further illustrated by the following examples.

### EXAMPLES

### 1. Measuring Methods

### Melt Flow Rate

The melt flow rate (MFR) is determined according to ISO 1133-1 and is indicated in g/10 min. The MFR is an indication of the flowability, and hence the processability, of the polymer. The higher the melt flow rate, the lower the viscosity of the polymer. The MFR₂ of polypropylene is determined at a temperature of 230° C. and a load of 2.16 kg. The MFR₂ of polyethylene is determined at a temperature of 190° C. and a load of 2.16 kg.

### Differential Scanning Calorimetry (DSC)

Differential scanning calorimetry (DSC) analysis, melting temperature (Tₘ) and melt enthalpy (Hm), crystallization temperature (Tc), and heat of crystallization (H_{c}. H_{CR}) are measured with a TA Instrument Q200 differential scanning calorimetry (DSC) on 5 to 7 mg samples. DSC is run according to ISO 11357/part 3/method C2 in a heat/cool/heat cycle with a scan rate of 10° C./min in the temperature range of −30 to +225° C. Crystallization temperature (Tc) and heat of crystallization (H_{c}) are determined from the cooling step, while melting temperature (Tₘ) and melt enthalpy (Hm) are determined from the second heating step.

### Xylene Cold Soluble (XCS)

Xylene Cold Soluble fraction at room temperature (XCS, wt.-%) is determined at 25° C. according to ISO 16152; 5th edition; 2005 Jul. 1.

### Tensile Properties

Tensile properties were determined according to ISO 527-2 (cross head speed=1 mm/min; test speed 50 mm/min at 23° C.) on a 1B specimen.

### Crystex Analysis

### Crystalline and Soluble Fractions Method

The crystalline (CF) and soluble fractions (SF) of the polypropylene (PP) compositions as well as the comonomer content and intrinsic viscosities of the respective fractions were analyzed by the CRYSTEX QC, Polymer Char (Valencia, Spain).

A schematic representation of the CRYSTEX QC instrument is shown in FIG. 1a. The crystalline and amorphous fractions are separated through temperature cycles of dissolution in 1,2,4-trichlorobenzene (1,2,4-TCB) at 160° C., crystallization at 40° C. and re-dissolution in 1,2,4-TCB at 160° C. as shown in FIG. 1b. Quantification of SF and CF and determination of ethylene content (C2) are achieved by means of an infrared detector (IR4) and an online 2-capillary viscometer is used for the determination of the intrinsic viscosity (iV).

IR4 detector is a multiple wavelength detector measuring IR absorbance at two different bands (CH₃ stretching vibration (centred at approx. 2960 cm⁻¹) and CHₓ stretching vibration (2700-3000 cm⁻¹)) which can be used to determine of the concentration and the ethylene content in ethylene-propylene copolymers. The IR4 detector is calibrated with series of 8 EP copolymers with known ethylene content in the range of 2 wt.-% to 69 wt.-% (determined by ¹³C-NMR) and each at various concentrations, in the range of 2 and 13 mg/ml. To account for both features, concentration and ethylene content at the same time for various polymer concentration expected during Crystex analyses the following calibration equations were applied:

$$Conc = a + b * Abs ( CH ) + c * {( Abs ( {CH}_{x} ) )}^{2} + d * Abs ( {CH}_{3} ) + e * ( {Abs ( {CH}_{3} )}^{2} + f * Abs ( {CH}_{x} ) * Abs ( {CH}_{3} ) \qquad ( Equation 1 )$$

$${CH}_{3} / 1000 C = a + b * Abs ( {CH}_{x} ) + c * Abs ( {CH}_{3} ) + d * ( Abs ( {CH}_{3} ) / Abs ( {CH}_{x} ) ) + e * {( Abs ( {CH}_{3} ) / Abs ( {CH}_{x} ) )}^{2} \qquad ( Equation 2 )$$

The constants a to e for equation 1 and a to f for equation 2 were determined by using least square regression analysis.

The CH₃/1000C is converted to the ethylene content in wt.-% using following relationship:

$$Wt . - \% ( Ethylene in EP Copolymers ) = 100 - {CH}_{3} / 1000 T C * 0.3 \qquad ( Equation 3 )$$

Amount of Soluble fraction (SF) and Crystalline Fraction (CF) are correlated through the XS calibration to the “Xylene Cold Soluble” (XCS) quantity and respectively Xylene Cold Insoluble (XCI) fractions, determined according to standard gravimetric method as per ISO16152. XS calibration is achieved by testing various EP copolymers with XS content in the range 2-31 Wt %. The determined XS calibration is linear:

$$Wt . - \% XS = 1 , 01 * Wt . - \% SF \qquad ( Equation 4 )$$

Intrinsic viscosity (IV) of the parent EP copolymer and its soluble and crystalline fractions are determined with a use of an online 2-capillary viscometer and are correlated to corresponding IV's determined by standard method in decalin according to ISO 1628-3. Calibration is achieved with various EP PP copolymers with IV=2-4 dL/g. The determined calibration curve is linear:

$$IV ( dL / g ) = a * Vsp / c \qquad ( equation 5 )$$

A sample of the PP composition to be analyzed is weighed out in concentrations of 10 mg/ml to 20 mg/ml. After automated filling of the vial with 1,2,4-TCB containing 250 mg/l 2,6-tert-butyl-4-methylphenol (BHT) as antioxidant, the sample is dissolved at 160° C. until complete dissolution is achieved, usually for 60 min, with constant stirring of 400 rpm. To avoid sample degradation, polymer solution is blanketed with the N2 atmosphere during dissolution. As shown in a FIGS. 1a and b, a defined volume of the sample solution is injected into the column filled with inert support where the crystallization of the sample and separation of the soluble fraction from the crystalline part is taking place. This process is repeated two times. During the first injection the whole sample is measured at high temperature, determining the IV[dl/g] and the C2[wt %] of the PP composition. During the second injection the soluble fraction (at low temperature) and the crystalline fraction (at high temperature) with the crystallization cycle are measured (Wt % SF, Wt % C2, IV).

### ¹³C NMR Spectroscopy-Based Determination of C2 Content for the Calibration Standards

Quantitative ¹³C{¹H} NMR spectra were recorded in the solution-state using a Bruker Avance III 400 NMR spectrometer operating at 400.15 and 100.62 MHz for ¹H and ¹³C respectively. All spectra were recorded using a ¹³C optimised 10 mm extended temperature probehead at 125° C. using nitrogen gas for all pneumatics. Approximately 200 mg of material was dissolved in 3 ml of 1,2-tetrachloroethane-d₂ (TCE-d₂) along with chromium (III) acetylacetonate (Cr (acac) 3) resulting in a 65 mM solution of relaxation agent in solvent (Singh, G., Kothari, A., Gupta, V., Polymer Testing 28 5 (2009), 475). To ensure a homogenous solution, after initial sample preparation in a heat block, the NMR tube was further heated in a rotatory oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimised tip angle, 1 s recycle delay and a bi-level WALTZ16 decoupling scheme (Zhou, Z., Kuemmerle, R., Qiu, X., Redwine, D., Cong, R., Taha, A., Baugh, D. Winniford, B., J. Mag. Reson. 187 (2007) 225, Busico, V., Carbonniere, P., Cipullo, R., Pellecchia, R., Severn, J., Talarico, G., Macromol. Rapid Commun. 2007, 28, 1128). A total of 6144 (6k) transients were acquired per spectra. Quantitative ¹³C{¹H} NMR spectra were processed, integrated and relevant quantitative properties determined from the integrals. All chemical shifts were indirectly referenced to the central methylene group of the ethylene block (EEE) at 30.00 ppm using the chemical shift of the solvent. This approach allowed comparable referencing even when this structural unit was not present. Characteristic signals corresponding to the incorporation of ethylene were observed (Cheng, H. N., Macromolecules 17 (1984), 1950) and the comonomer fraction calculated as the fraction of ethylene in the polymer with respect to all monomer in the polymer: fE=(E/(P+E) The comonomer fraction was quantified using the method of Wang et. al. (Wang, W-J., Zhu, S., Macromolecules 33 (2000), 1157) through integration of multiple signals across the whole spectral region in the ¹³C{¹H} spectra. This method was chosen for its robust nature and ability to account for the presence of regio-defects when needed. Integral regions were slightly adjusted to increase applicability across the whole range of encountered comonomer contents. For systems with very low ethylene content where only isolated ethylene in PPEPP sequences were observed the method of Wang et. al. was modified reducing the influence of integration of sites that are no longer present. This approach reduced the overestimation of ethylene content for such systems and was achieved by reduction of the number of sites used to determine the absolute ethylene content to E=0.5 (Sββ+Sβγ+Sβδ+0.5 (Sαβ+Sαγ)) Through the use of this set of sites the corresponding integral equation becomes E=0.5 (I_{H}+I_{G}+0.5 (I_{C}+I_{D}))) using the same notation used in the article of Wang et. al. (Wang, W-J., Zhu, S., Macromolecules 33 (2000), 1157). Equations used for absolute propylene content were not modified. The mole percent comonomer incorporation was calculated from the mole fraction: E [mol %]=100*fE. The weight percent comonomer incorporation was calculated from the mole fraction: E [wt %]=100*(fE*28.06)/((fE*28.06)+ ((1−fE)*42.08))

Comonomer Content Quantification of Poly(Propylene-Co-Ethylene) Copolymers by Quantitative ¹³C{¹H} NMR Measurement

Quantitative ¹³C{¹H} NMR spectra were recorded in the solution-state using a Bruker Avance NEO 400 NMR spectrometer operating at 400.15 and 100.62 MHz for ¹H and ¹³C respectively. All spectra were recorded using a ¹³C optimised 10 mm extended temperature probe head at 125° C. using nitrogen gas for all pneumatics. Approximately 200 mg of material was dissolved in 3 ml of 1,2-tetrachloroethane-d₂ (TCE-d₂) along with chromium-(III)-acetylacetonate (Cr (acac) 3) resulting in a 60 mM solution of relaxation agent in solvent {8} and with approximately 3 mg BHT (2,6-di-tert-butyl-4-methylphenol CAS 128-37-0). To ensure a homogenous solution, after initial sample preparation in a heat block, the NMR tube was further heated in a rotatory oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimised tip angle, 1 s recycle delay and a bi-level WALTZ16 decoupling scheme {3, 4}. A total of 6144 (6k) transients were acquired per spectra. Quantitative ¹³C{¹H} NMR spectra were processed, integrated and relevant quantitative properties determined from the integrals using proprietary computer programs. All chemical shifts were indirectly referenced to the central methylene group of the ethylene block (EEE) at 30.00 ppm using the chemical shift of the solvent. This approach allowed comparable referencing even when this structural unit was not present. Characteristic signals corresponding to the incorporation of ethylene were observed {7}.

The comonomer fraction was quantified using the method of Wang et. al. {6} through integration of multiple signals across the whole spectral region in the ¹³C{¹H} spectra. This method was chosen for its robust nature and ability to account for the presence of regiodefects when needed. Integral regions were slightly adjusted to increase applicability across the whole range of encountered comonomer contents.

For systems where only isolated ethylene in PPEPP sequences was observed the method of Wang et al. was modified to reduce the influence of non-zero integrals of sites that are known to not be present. This approach reduced the overestimation of ethylene content for such systems and was achieved by reduction of the number of sites used to determine the absolute ethylene content to:

$$E = 0.5 ( S ββ + S βγ + S βδ + 0.5 ( S αβ + S αγ ) )$$

Through the use of this set of sites the corresponding integral equation becomes:

$$E = 0.5 ( {I}_{H} + {I}_{G} + 0.5 ( {I}_{C} + {I}_{D} ) )$$

using the same notation used in the article of Wang et al. {6}. Equations used for absolute propylene content were not modified.

The mole percent comonomer incorporation was calculated from the mole fraction:

$$E [ mol \% ] = 100 * fE$$

The weight percent comonomer incorporation was calculated from the mole fraction:

$$E [ wt \% ] = 100 * ( fE * 28.06 ) / ( ( fE * 28.06 ) + ( ( 1 - fE ) * 42.08 ) )$$

### BIBLIOGRAPHIC REFERENCES

1) Busico, V., Cipullo, R., Prog. Polym. Sci. 26 (2001) 443.
2) Busico, V., Cipullo, R., Monaco, G., Vacatello, M., Segre, A. L., Macromolecules 30 (1997) 6251.
3) Zhou, Z., Kuemmerle, R., Qiu, X., Redwine, D., Cong, R., Taha, A., Baugh, D. Winniford, B., J. Mag. Reson. 187 (2007) 225.
4) Busico, V., Carbonniere, P., Cipullo, R., Pellecchia, R., Severn, J., Talarico, G., Macromol. Rapid Commun. 2007, 28, 1128.
5) Resconi, L., Cavallo, L., Fait, A., Piemontesi, F., Chem. Rev. 2000, 100, 1253.
6) Wang, W-J., Zhu, S., Macromolecules 33 (2000), 1157.
7) Cheng, H. N., Macromolecules 17 (1984), 1950.
8) Singh, G., Kothari, A., Gupta, V., Polymer Testing 28 5 (2009), 475.
9) Kakugo, M., Naito, Y., Mizunuma, K., Miyatake, T. Macromolecules 15 (1982) 1150.
10) Randall, J. Macromol. Sci., Rev. Macromol. Chem. Phys. 1989, C29, 201.
11) Resconi, L., Cavallo, L., Fait, A., Piemontesi, F., Chem. Rev. 2000, 100, 1253.

### Intrinsic Viscosity

The intrinsic viscosity (iV) is measured according to DIN ISO 1628/1, October 1999, in Decalin at 135° C.

F₃₀ Melt Strength and v₃₀ Melt Extensibility

The test described herein follows ISO 16790:2005.

The strain hardening behaviour is determined by the method as described in the article “Rheotens-Mastercurves and Drawability of Polymer Melts”, M. H. Wagner, Polymer Engineering and Sience, Vol. 36, pages 925 to 935. The content of the document is included by reference. The strain hardening behaviour of polymers is analysed by Rheotens apparatus (product of Göttfert, Siemensstr.2, 74711 Buchen, Germany) in which a melt strand is elongated by drawing down with a defined acceleration.

The Rheotens experiment simulates industrial spinning and extrusion processes. In principle a melt is pressed or extruded through a round die and the resulting strand is hauled off. The stress on the extrudate is recorded, as a function of melt properties and measuring parameters (especially the ratio between output and haul-off speed, practically a measure for the extension rate). For the results presented below, the materials were extruded with a lab extruder HAAKE Polylab system and a gear pump with cylindrical die (L/D=6.0/2.0 mm). The gear pump was pre-adjusted to a strand extrusion rate of 5 mm/s, and the melt temperature was set to 200° C. The spinline length between die and Rheotens wheels was 80 mm. At the beginning of the experiment, the take-up speed of the Rheotens wheels was adjusted to the velocity of the extruded polymer strand (tensile force zero): Then the experiment was started by slowly increasing the take-up speed of the Rheotens wheels until the polymer filament breaks. The acceleration of the wheels was small enough so that the tensile force was measured under quasi-steady conditions. The acceleration of the melt strand drawn down is 120 mm/sec². The Rheotens was operated in combination with the PC program EXTENS. This is a real-time data-acquisition program, which displays and stores the measured data of tensile force and drawdown speed. The end points of the Rheotens curve (force versus pulley rotary speed) is taken as the F₃₀ melt strength and drawability values.

### Density

Density is measured according to ISO 1183-187. Sample preparation is done by compression moulding in accordance with ISO 1872-2:2007.

### Density of the Foam

This has been measured using an analytical and semi-micro precision balance of Switzerland PRECISA Gravimetrics AG, Switzerland, the specific gravity balance (XS225A); test method: application of Archimedes, automatically calculate the density of the sample.

### Cell Size Diameter of the Foam

The cell size diameter of the foam was determined using a light optical microscope of Tawain CBS Stereoscopic microscope;

The testing method used is as follows:
1. Cut a strip of the foamed material along the cross direction (CD) and machine direction (MD).
2. Hold the foamed material with a flat clamp and use a razor blade to perform a fine shave.
3. Focus the microscope at 100× and adjust lighting onto the foamed material.
4. Perform length and width measurements of each unique cell in the CD and MD orientation and record values.
5. Count the number of measured unique cells and record the values.
6. Perform cell wall thickness measurements across 3-4 tangent lines to overall length of each unique cell in the CD and MD orientation and record the values.
7. Perform three overall strip thickness measurements starting from the bottom of the first measured cell group, to the middle of the cell group, to the top of the cell group.
8. Perform an overall length measurement starting from the lowest complete cell to the highest complete cell.
9. Move microscope visual field so the bottom of the most upper incomplete cell is touching the bottom of the screen.
10. Repeat steps 4-9 on each new unique cell until about 0.200″ to 0.800″ of the strip is measured. Ensure that the overall length and cell composition does not overlap. Each overall length measurement after the first measurement is taken from the top of the previous highest complete cell to the top of the current highest complete cell.

### Flexural Modulus

The flexural modulus was determined in 3-point-bending according to ISO 178 on 80×10×4 mm³ test bars injection molded at 23° C. in line with EN ISO 1873-2.

### Puncture Energy and Energy to Max Force

Puncture energy and Energy to max Force were determined on plaques with dimensions 60×60×3 mm³ machined from injection-molded plaques using an instrumented falling weight impact testing according to ISO 6603-2. The test was performed at either 23° C. or −20° C. (as indicated) with a lubricated tip with a diameter of 20 mm and impact velocity of 4.4 mm/s. Six specimens were tested for each sample and the resulting six force-deflection curves were used to calculate the mean value for energy to maximum force and puncture energy. In addition impact failure type was evaluated. ISO6603-2 defines the following impact failure types, the number in brackets was assigned to calculate a numeric value for impact failure (mean value derived from six tested samples):
YD yielding (zero slope at maximum force) followed by deep drawing (1)
YS yielding (zero slope at maximum force) followed by (at least partially) stable cracking (2)
YU yielding (zero slope at maximum force) followed by unstable cracking (3)
NY no yielding (4).

### GPC-VISC-MALS Analysis (Branching Index)

### GPC Measurement

A gel permeation chromatograph (GPC) manufactured by PolymerChar (Valencia, Spain) equipped with an infra-red detector (IR5), an online four capillary bridge viscometer and a multi-angle light scattering (MALS) detector (Dawn Helios 2) with 18 angles ranging from around 22.5° to 147.0° from Wyatt technology (Santa Barabara, USA) was used. 3× Olexis and 1× Olexis Guard columns from Agilent as stationary phase and 1,2,4-trichlorobenzene (TCB, stabilized with 250 mg/L 2,6-Di tert butyl-4-methyl-phenol) as mobile phase at 160° C. and at a constant flow rate of 1 mL/min was applied. The polymer sample was dissolved at a concentration of 1 mg/ml at 160° C. for 150 min in TCB. 200 μl of the polymer solution were injected per analysis. The injected concentration of the polymer solution at 160° C. (c_{160° C.}) was determined in the following way.

### GPC-VISC-MALS

The IV detector was calibrated with NIST1475a using a nominal IV of 1.01 dl/g. The inter-detector volume between the different detectors, concentration (IR), LS and viscometer detector was achieved by analysing a narrow distributed PS standard having a molar mass of 30 000 g/mol.

For the determination of MWD using GPC-VISC-MALS technique the normalisation of the different MALS angles was obtained with a narrow distributed PS standard having a molar mass of 30 000 g/mol. The MALS detector was calibrated with certified PE standard, NIST1475a with a Mw of 54 000 g/mol using a dn/dc of 0.094 m¹/mg at a laser wavelength (2) of 660 nm. For calculation of the molecular weight, the laser wavelength (2) of 660 nm and a dn/dc of 0.094 m¹/mg for the PP in TCB solution were used. Due to the higher baseline noise and frequent disturbances, the MALS signal of the smallest 3 angles were not used in all calculations. Because of the low sample concentration used, the second viral coefficient (A2=0) was neglected. The absolute Mw at each chromatographic slice and the corresponding radius of gyration (R_{g}) were obtained from the slope and the intercept of the Debye plot (Reference: Wyatt, P. J. (1993) Analy. Chim. Acta, Light Scattering and the Absolute Characterisation of Macromolecules. 272, 1-40). Zimm formulism was used for extrapolation of the corresponding Rayleigh ratios (R(Θ))) of the different angles.

Molecular weight averages (Mz(LS), Mw(LS) and Mn(LS)), Molecular weight distribution (MWD) and its broadness, described by polydispersity, PD(LS)=Mw(LS)/Mn(LS) (wherein Mn(LS) is the number average molecular weight and Mw(LS) is the weight average molecular weight obtained from GPC-LS) were calculated by Gel Permeation Chromatography (GPC) using the following formulas:

$${M}_{n} ( LS ) = \frac{{\sum }_{i = 1}^{N} {A}_{i}}{\sum ( {A}_{i} / {M}_{i ( LS )} )}$$

$${M}_{w} ( LS ) = \frac{{\sum }_{i = 1}^{N} ( {A}_{i} \times {M}_{i ( LS )} )}{\sum {A}_{i}}$$

$${M}_{z} ( LS ) = \frac{{\sum }_{i = 1}^{N} ( {A}_{i} \times {M}_{i ( LS )}^{2} )}{\sum ( {A}_{i} / {M}_{i} ( LS ) )}$$

For a constant elution volume interval ΔVᵢ, where Aᵢ and M_{i(LS)} are the chromatographic peak slice area and polyolefin molecular weight (MW) determined by GPC-MALS respectively associated with the elution volume, Vᵢ.

The corresponded bulk IV (bulk) and bulk M_{w} (bulk) values are calculated in the following way:

$${M}_{w} ( bulk ) = \frac{{Area}_{{LS}_{zero}}}{{Area}_{IR}} * \frac{K ( Mals )}{{( dn / dc )}^{2}}$$

$$IV ( bulk ) = \frac{{Area}_{SpVisc}}{{Area}_{IR} * KIV}$$

Where Area_{IR}, Area_{Lszero} and Area_{SpVisc} are the area of the concentration signal (IR5), the area of the extrapolated LS signal at 0° angle and the area of the specific viscosity. KIV and K (MALS) are the corresponded detector constants.

### GPC Conventional

The column set was calibrated using universal calibration with 19 polystyrene (PS) standards with a narrow molecular weight distribution (MWD) in the range of 0.5 kg/mol to 11 500 kg/mol. The PS standards were dissolved for 30 min at 160° C. The conversion of the polystyrene peak molecular weight to corresponding polyolefine molecular weights is accomplished by using Mark Houwink equation and corresponding Mark Houwink constants:

$${K}_{PS} = 19 \times {10}^{- 3} mL / g , {α}_{PS} = 0.655$$

$${K}_{PP} = 19 \times {10}^{- 3} mL / g , {α}_{PP} = 0.725$$

$${K}_{PE} = 39 \times {10}^{- 3} mL / g , {α}_{PP} = 0.725$$

A third order polynomial fit was used to fit the calibration data.

Molecular weight averages (Mz, Mw and Mn), Molecular weight distribution (MWD) and its broadness, described by polydispersity index, PDI=Mw/Mn(wherein Mn is the number average molecular weight and Mw is the weight average molecular weight) were determined by Gel Permeation Chromatography (GPC) using the following formulas:

$${M}_{n} = \frac{{\sum }_{i = 1}^{N} {A}_{i}}{{\sum }_{i = 1}^{N} ( {A}_{i} / {M}_{i} )}$$

$${M}_{w} = \frac{{\sum }_{i = 1}^{N} ( {A}_{i} \times {M}_{i} )}{{\sum }_{i = 1}^{N} {A}_{i}}$$

$${M}_{z} = \frac{{\sum }_{i = 1}^{N} ( {A}_{i} \times {M}_{i}^{2} )}{{\sum }_{i = 1}^{N} ( {A}_{i} / {M}_{i} )}$$

$${IV}_{conv} = {K}_{pp} \frac{{\sum }_{i = 1}^{N} ( {A}_{i} \times {{M}_{i}}^{{α}_{PP}} )}{{\sum }_{i = 1}^{N} {A}_{i}}$$

For a constant elution volume interval ΔVᵢ, where Aᵢ, and Mᵢ are the chromatographic peak slice area and polyolefin molecular weight (MW), respectively associated with the elution volume, Vᵢ.

Branching Index (gpcBR Index):

The gpcBR index is calculated by using the following formula:

$${gpc}_{BR} = [ ( \frac{{IV}_{conv}}{IV ( bulk )} ) ] \cdot {[ \frac{{M}_{w} ( bulk )}{{M}_{w}} ]}^{α} - 1$$

All GPC calculation were performed using GPCone Software from PolymerChar.

### 2. Experiments

### a) Polymerisation of Heterophasic Propylene Copolymer (A)

The heterophasic propylene copolymer A used in the present invention was polymerized using techniques well known in the art, using polymerization conditions given in Table 1. The catalyst used for HECO A was an emulsion-type Ziegler-Natta catalyst, being identical to the catalyst employed in the polymerization of the inventive examples of WO 2017/148970 A1.

The cocatalyst was TEAL and the external donor was dicyclopentyldimethoxysilane (Donor D).

Following polymerization under the conditions given in Table 1, the reactor-made polymer was additivated with standard polypropylene additives, as is indicated at the bottom of Table 1. The properties of additivated HECO A are also given in Table 1.

TABLE 1
Polymerization conditions and properties of HECO A

| Parameter | | HECO A |
|---|---|---|
| TEAL/Ti | [mol/mol] | 36 |
| TEAL/Donor | [mol/mol] | 7 |
| Prepolymerization | | |
| Temperature | [° C.] | 28 |
| Residence time | [h] | 0.27 |
| Loop R1 | | |
| R1 Temperature | [° C.] | 75 |
| R1 Pressure | [bar] | 50 |
| R1 Residence time | [h] | 0.32 |
| R1 H2/C3 ratio | [mol/kmol] | 19.6 |
| R1 C2/C3 | [mol/kmol] | 0 |
| R1 Split | [%] | 41 |
| R1 NFR 2 | [g/10 min] | 179 |
| R1 XCS | [wt %] | 3.5 |
| GPR1 R2 | | |
| R2 Temperature | [° C.] | 80 |
| R2 Pressure | [bar] | 21 |
| R2 Residence time | [h] | 2.72 |
| R2 C2/C3 ratio | [mol/kmol] | 0 |
| R2 H2/C3 ratio | [mol/kmol] | 159.7 |
| R2 split | [%] | 30 |
| R2 MFR2 | [g/10 min] | 159 |
| R2 XCS | [wt %] | 2.8 |
| R2 Ethene content | [wt %] | 0 |
| GPR2 R3 | | |
| R3 Temperature | [° C.] | 75 |
| R3 Pressure | [bar] | 19 |
| R3 Residence time | [h] | 0.28 |
| R3 C2/C3 ratio | [mol/kmol] | 2.8 |
| R3 H2/C2 ratio | [mol/kmol] | 273.1 |
| R3 split | [%] | 12 |
| R3 MFR2 | [g/10 min] | 89 |
| R3 XCS | [wt %] | 2.3 |
| R3 C2 | [wt %] | 0 |
| R3 C2(XCS) | [wt %] | 0 |
| GPR3 R4 | | |
| R4 Temperature | [° C.] | 80 |
| R4 Pressure | [bar] | 17 |
| R4 Residence time | [h] | 0.21 |
| R4 C2/C3 ratio | [mol/kmol] | 345.4 |
| R4 H2/C3 ratio | [mol/kmol] | 79.6 |
| R4 split | [%] | 17 |
| Final product | | |
| MFR2 | [g/10 min] | 40 |
| C2 content | [wt %] | 7.6 |
| XCS | [wt %] | 19 |
| C2(XCS) | [wt %] | 40 |
| IV(XCS) | [dl/g] | 3.2 |

Talc HM2 manufactured by IMI-Fabi (Italy) having a median particle size d50 of 2.4 μm, a cutoff particle size d95 of 7.7 μm and a specific surface of 21 m²/g.
GlySt Glycerol Stearate, CAS-No 31556-31-1, is commercially available from Danisco (DuPont Group)
Irganox B 215 A blend of 2:1 Irgafox 168 and Irganox 1010, acting as process and long-term thermal stabilizer, commercially available from BASF SE
CaSt Calcium Stearate, CAS-No 1592-23-0, is commercially available from Faci

### b) Blended Compositions and Unfoamed Plaques

Unfoamed inventive and comparative compositions IC1, IC2 and CC3 were prepared according to the recipes given in Table 2.

Thereby in a first step the components were melt blended in a co-rotating twin screw extruder in amounts as indicated in Table 1. The polymer melt mixture was discharged and pelletized. In a second step the pelletized polymer melt mixtures were subjected to injection moulding performed on an Engel E380 machine to produce injection moulded plaques having a thickness as listed below in Table 2.

PPH B is the commercially available high melt strength propylene homopolymer Daploy™ WB140HMS, available from Borealis AG.

PE C is the commercially available ethylene-octene plastomer Queo 7001LA, having a melt flow rate MFR₂ of 1 g/10 min, a density of 870 kg/m³ and a melting temperature of 56° C., available from Borealis AG.

The properties of the final compositions and of the unfoamed plaques are given in Table 2.

TABLE 2
Compositions and properties of unfoamed
plaques IC1, IC2 and CC3

| Compounding | | IC1 | IC2 | CC3 |
|---|---|---|---|---|
| HECO A | [wt. %] | 90 | 80 | 100 |
| PPH B | [wt. %] | 10 | 10 | — |
| PE C | [wt. %] | — | 10 | — |
| Properties | | | | |
| Thickness of plaque | [mm] | 1.90 | 1.89 | 1.89 |
| MFR₂ | [g/10 min] | 26 | 20 | 35 |
| Density | [kg/m³] | 907.1 | 907.5 | 908.5 |
| Flexural modulus | [MPa] | 1719 | 1443 | 1526 |
| Tensile modulus | [MPa] | 1744 | 1448 | 1667 |
| Tensile strain at break | [%] | 16.85 | 54.14 | 30.66 |
| Tensile strain at tensile strength | [%] | 4.37 | 5.65 | 4.23 |
| Tensile strain at yield | [%] | 4.37 | 5.65 | 4.23 |
| Tensile strength | [MPa] | 30.04 | 25.77 | 28.18 |
| Tensile stress at break | [MPa] | 20.82 | 19.85 | 18.87 |
| Tensile stress at yield | [MPa] | 30.04 | 25.77 | 28.18 |
| Energy to max force | [J] | 15.90 | 14.49 | 15.11 |
| Max force | [N] | 2458 | 2171 | 2288 |
| Puncture energy | [J] | 23.01 | 26.45 | 24.38 |

### c) Branching Index of Melt Blended Polypropylene Composition

Inventive, melt blended polypropylene compositions B, C and D and reference, melt blended polypropylene compositions A, E and F were prepared according to the recipes given in Table 3. The branching index was determined according to the GPC-VISC-MALS analysis described herein above.

TABLE 3

| | | HECO A | PPH | Branching |
|---|---|---|---|---|
| Example | | [wt. %] | [wt. %] | index |
| A | Reference | 100 | 0 | 0 |
| B | Inventive | 95 | 5 | 0.06 |
| C | Inventive | 90 | 10 | 0.14 |
| D | Inventive | 80 | 20 | 0.28 |
| E | Reference | 70 | 30 | 0.41 |
| F | Reference | 0 | 100 | 1.52 |

### d) Foaming Compositions and Foamed Plaques

Injection-moulding foaming was performed on an Engel E380 machine introducing the pelletized polymer melt mixtures with the compositions as listed above in Table 2 for unfoamed compositions IC1, IC2 and CC3 together with the chemical blowing agents CFA 1, CFA 2 or CFA 3 in the amounts as listed in Table 3 below. The materials were foamed using core back technology from 2 mm starting thickness to an end thickness as listed in Table 3.
CFA 1 chemical foaming agent Panthelene H65C, commercially available from EIWA CHEMICAL IND. CO., LTD
CFA 2 chemical foaming agent Panthelene H25C, commercially available from EIWA CHEMICAL IND. CO., LTD
CFA 3 chemical foaming agent Maxithen HP 788810/20 TR, commercially available from Gabriel-Chemie GmbH.

The properties of the foamed plaques are given in Table 4.

From the properties of Table 4 below it can be seen that depending on the chemical foaming agent either the puncture energy can be increased at comparable flexural modulus (CFA 3) or the flexural modulus can be increased at comparable puncture energy (CFA 1 and CFA 2). Thereby, introduction of the copolymer of ethylene PE 3 increases the puncture energy. Further, introduction of CFA 3 results in a higher density reduction.

TABLE 4
Compositions and properties of foamed plaques of examples IE1-IE6 and CE1-CE3

| | | CE1 | CE2 | CE3 | IE1 | IE2 | IE3 | IE4 | IE5 | IE6 |
|---|---|---|---|---|---|---|---|---|---|---|
| Compounding | | | | | | | | | | |
| Composition | | CC1 | CC1 | CC1 | IC1 | IC1 | IC1 | IC1 | IC1 | IC |
| CFA 1 | [wt. %] | 1.8 | — | — | 1.8 | — | — | 2.0 | — | — |
| CFA 2 | [wt. %] | — | 2.8 | — | — | 2.8 | — | — | 2.8 | — |
| CFA 3 | [wt. %] | — | — | 1.8 | — | — | 1.8 | — | — | 1.8 |
| Properties | | | | | | | | | | |
| Thickness before activation | [mm] | 2 | 2 | 2 | 2 | 2 | 2 | 2 | 2 | 2 |
| Thickness of foamed plaque | [mm] | 3.28 | 3.14 | 3.61 | 3.03 | 3.14 | 3.79 | 3.15 | 3.03 | 3.50 |
| Density | [kg/m³] | 495.0 | 490.9 | 433.6 | 526.3 | 510.4 | 431.7 | 465.8 | 516.7 | 440.9 |
| Density reduction (compared | [%] | 46 | 46 | 52 | 42 | 44 | 52 | 49 | 43 | 51 |
| unfoamed plaque) | | | | | | | | | | |
| Average cell size MD | [μm] | 119 | n.m. | 167 | 114 | n.m. | 149 | 109 | n.m. | 138 |
| Average cell size TD | [μm] | 210 | n.m. | 198 | 127 | n.m. | 192 | 130 | n.m. | 163 |
| Flexural modulus | [MPa] | 796 | 833 | 682 | 946 | 921 | 705 | 799 | 803 | 694 |
| Tensile modulus | [MPa] | 607 | 593 | 486 | 705 | 692 | 455 | 523 | 527 | 441 |
| Tensile strain at break | [%] | 24.33 | 25.12 | 30.30 | 29.17 | 31.71 | 35.94 | 53.45 | 47.32 | 61.29 |
| Tensile strain at tensile strength | [%] | 7.68 | 7.39 | 11.24 | 5.87 | 5.66 | 10.75 | 17.32 | 14.40 | 16.80 |
| Tensile strain at yield | [%] | 7.68 | 7.39 | 11.24 | 5.87 | 5.66 | 10.75 | 17.32 | 14.40 | 16.80 |
| Tensile strength | [MPa] | 9.86 | 9.49 | 8.17 | 11.99 | 11.70 | 7.99 | 9.43 | 9.50 | 8.21 |
| Tensile stress at break | [MPa] | 9.54 | 9.15 | 7.85 | 11.33 | 10.99 | 7.61 | 8.93 | 8.97 | 7.64 |
| Tensile stress at yield | [MPa] | 9.86 | 9.49 | 8.17 | 11.99 | 11.70 | 7.99 | 9.43 | 9.50 | 8.21 |
| Energy to max force | [J] | 2.68 | 2.39 | 1.88 | 2.45 | 2.27 | 2.52 | 3.98 | 2.80 | 8.23 |
| Max force | [N] | 598 | 598 | 703 | 590 | 622 | 776 | 971 | 765 | 1390 |
| Puncture energy | [J] | 3.10 | 3.10 | 2.83 | 2.84 | 2.82 | 2.84 | 5.79 | 5.24 | 8.65 |

n.m. not measured

1. A polypropylene composition having a melt flow rate MFR₂ of from 10.0 to 55.0 g/10 min, determined according to ISO 1133 at a temperature of 230° C. and a load of 2.16 kg, the polypropylene composition comprising
(A) from 55.0 to 97.5 wt.-%, based on the total weight of the composition, of a heterophasic propylene copolymer comprising a matrix phase and an elastomeric phase dispersed in said matrix phase and having an amount of xylene cold solubles (XCS) fraction of from 10.0 to 25.0 wt.-%, based on the total amount of the heterophasic propylene copolymer (A);
(B) from 2.5 to 25.0 wt.-%, based on the total weight of the composition, of a high melt strength propylene homopolymer having a melt flow rate MFR₂ of from 0.5 to 5.0 g/10 min, determined according to ISO 1133 at a temperature of 230° C. and a load of 2.16 kg;
(C) from 0 to 20.0 wt.-%, based on the total weight of the composition, of a copolymer of ethylene with at least one comonomer selected from alpha-olefins having from 4 to 10 carbon atoms, having a density of from 860 to 880 kg/m³, determined according to ISO 1183, and a melt flow rate MFR₂ of from 0.1 to 2.5 g/10 min, determined according to ISO 1133 at a temperature of 190° C. and a load of 2.16 kg.

2. The polypropylene composition according to claim 1, wherein the composition has
a density of from 890 to 1100 kg/m³, determined according to ISO 1183; and/or
a melt flow rate MFR₂ of from 15.0 to 50.0 g/10 min, determined according to ISO 1133 at a temperature of 230° C. and a load of 2.16 kg.

3. The polypropylene composition according to claim 1, wherein the composition has one or more or all of the following properties:
a tensile modulus of from 1200 to 2000 MPa, measured according to ISO 527-1; and/or
a tensile strain at break of from 10 to 75%, measured according to ISO 527-1; and/or
a tensile strength of from 15 to 50 MPa, measured according to ISO 527-1; and/or
a tensile stress at break of from 10 to 35 MPa, measured according to ISO 527-1; and/or
a flexural modulus of from 1200 to 2000 MPa, measured according to ISO 178; and/or
a puncture energy of from 15 to 35 J, measured according to ISO 6603-2 at 23° C.; and/or
a max force at 23° C. of from 1750 to 2750 N, measured according to ISO 6603-2 at 23° C.; and/or
an energy to max force at 23° C. of from 10 to 20 J, measured according to ISO 6603-2 at 23° C.

4. The polypropylene composition according to claim 1, wherein the heterophasic propylene copolymer (A) has one or more or all of the following properties:
a melt flow rate MFR₂, measured according to ISO 1133-1 at 230° C. at a load of 2.16 kg, in the range from 15.0 to 100.0 g/10 min; and/or
the amount of the xylene cold solubles fraction (XCS) determined at 25° C. according to ISO 16152 is in the range from 12.5 to 20.0 wt.-%, based on the total weight of the heterophasic propylene copolymer (A); and/or
an intrinsic viscosity of the xylene cold solubles fraction (IV (XCS)) in the range from 2.00 to 4.00 dl/g, determined according to DIN ISO 1628/1 in decalin; and/or
an ethylene content of the xylene cold solubles fraction (C2(XCS)), measured by quantitative ¹³C{¹H} NMR measurement, in the range from 20.0 to 60.0 wt.-%; and/or
a total ethylene content (C2), measured by quantitative ¹³C{¹H} NMR measurement, in the range from 3.0 to 15.0 wt.-%.

5. The polypropylene composition according to claim 1, wherein the heterophasic propylene copolymer (A) comprises two heterophasic propylene copolymers (A-1) and (A-2), wherein heterophasic propylene copolymer (A-1) has a lower melt flow rate MFR₂ as heterophasic propylene copolymer (A-2) and the weight ratio of heterophasic propylene copolymer (A-1) to heterophasic propylene copolymer (A-2) in the polypropylene composition is in the range of from 40:60 to 60:40.

6. The polypropylene composition according to claim 1, wherein the high melt strength propylene homopolymer (B) is branched and the branches are introduced into the polymer chains of the high melt strength propylene homopolymer (B) as side chains by polymerization in the presence of a single site catalyst or by chemical modification.

7. The polypropylene composition according to claim 1, wherein the high melt strength propylene homopolymer (B) has a melt strength F₃₀ (ISO 16790:2005) of 20.0 to 50.0 cN; and/or a melt extensibility v₃₀ (ISO 16790:2005) in the range of 190 to 320 mm/s.

8. The polypropylene composition according to claim 1, wherein the ethylene copolymer (C) is a copolymer of ethylene and 1-octene comonomer units.

9. An injection-molded article comprising the polypropylene composition according to claim 1.

10. The injection-molded article according to claim 9, wherein the article has one or more or all of the following properties:
a tensile modulus of from of from 1200 to 2000 MPa, measured according to ISO 527-1; and/or
a tensile strain at break of from 10 to 75%, measured according to ISO 527-1; and/or
a tensile strength of from 15 to 50 MPa, measured according to ISO 527-1; and/or
a tensile stress at break of from 10 to 35 MPa, measured according to ISO 527-1; and/or
a flexural modulus of from 1200 to 2000 MPa, measured according to ISO 178; and/or
a puncture energy of from 15 to 35 J, measured according to ISO 6603-2 at 23° C.; and/or
a max force at 23° C. of from 1750 to 2750 N, measured according to ISO 6603-2 at 23° C.; and/or
an energy to max force at 23° C. of from 10 to 20 J, measured according to ISO 6603-2 at 23° C.

11. A foamed article
comprising the polypropylene composition according to claim 1.

12. The foamed article according to claim 11, wherein the polypropylene composition is foamed in the presence of a foaming agent.

13. The foamed article according to claim 11, wherein the article has one or more or all of the following properties:
a density measured according to ISO 1183 of from 350 to 650 kg/m³;
a flexural modulus measured according to ISO 178 of from 600 to 1200 MPa;
a tensile modulus measured according to ISO 527 of from 350 to 800 mPa;
a tensile strain at break of from 20 to 100%;
a tensile strain at tensile strength measured according to ISO 527 of from 2.0 to 7.5%;
a tensile strain at yield measured according to ISO 527 of from 2.5 to 30.0%;
a tensile strength measured according to ISO 527 of from 5.0 to 20.0 MPa;
a tensile stress at break measured according to ISO 527 of from 5.0 to 20.0 MPa;
a tensile stress at yield measured according to ISO 527 of from 5.0 to 20.0 MPa;
an energy to max force measured according to ISO 6603-2 at 23° C. of from 1.8 to 10.0 J; and/or
a puncture energy measured according to ISO 6603-2 at 23° C. of from 2.0 to 10.0 J.

14. The foamed article according to claim 11, wherein the flexural modulus measured according to ISO 178 is in the range of from 500 to 1500 MPa lower than the flexural modulus of an unfoamed injection-molded article measured according to ISO 178.

15. A method for producing a foamed article, comprising using the polypropylene composition according to claim 1 in combination with a chemical foaming agent.

16. The polypropylene composition according to claim 1, wherein
the amount of the heterophasic propylene copolymer (A) is in a range of from 70.0 to 95.0 wt.-%, based on the total weight of the composition;
the amount of the high melt strength propylene homopolymer (B) is in a range of from 5.0 to 15.0 wt.-%, based on the total weight of the composition; and
the amount of the copolymer of ethylene (C) is in a range of from 0 to 12.5 wt.-%, based on the total weight of the composition.

17. The polypropylene composition according to claim 1, wherein the melt flow rate MFR₂ of the polypropylene composition is in a range of from 17.0 to 45.0 g/10 min, determined according to ISO 1133 at a temperature of 230° C. and a load of 2.16 kg.

18. The polypropylene composition according to claim 1, wherein the heterophasic propylene copolymer (A) has a melt flow rate MFR₂, measured according to ISO 1133-1 at 230° C. at a load of 2.16 kg, in the range from 20.0 to 90.0 g/10 min.

19. The polypropylene composition according to claim 1, wherein the heterophasic propylene copolymer (A) has a melt flow rate MFR₂, measured according to ISO 1133-1 at 230° C. at a load of 2.16 kg, in the range from 30.0 to 80.0 g/10 min.

20. The polypropylene composition according to claim 1, wherein the high melt strength propylene homopolymer (B) has a melt strength F₃₀ (ISO 16790:2005) of 25.0 to 45.0 cN.
